(19) United States
(12) Patent Application Publication
(10) Pub. No.: US 2023/0211519 A1
(43) Pub. Date: Jul. 6, 2023

(54) HIGH POWER COMPACT CORDLESS CHAINSAW

(71) Applicant: MILWAUKEE ELECTRIC TOOL CORPORATION, Brookfield, WI (US)

(72) Inventors: Robert L. Markus, Brookfield, WI (US); Kegan Markwardt, West Allis, WI (US); Michael T. Newby, Brookfield, WI (US); Robert J. Wong, Brookfield, WI (US)

(21) Appl. No.: 18/093,989

(22) Filed: Jan. 6, 2023

Related U.S. Application Data
(60) Provisional application No. 63/296,907, filed on Jan. 6, 2022.

(51) Int. Cl. B27B 17/02; B27B 17/08; B27B 17/12; B27B 17/00

(52) U.S. Cl. CPC B27B 17/02; B27B 17/08; B27B 17/12; B27B 17/0008

(57) ABSTRACT

A chainsaw configured to be powered by a battery pack. The chainsaw includes a housing, a guide bar, and a power and drive assembly. The housing includes a battery interface for receiving the battery pack. The guide bar guides a cutting chain and is removably coupled to the housing. The power and drive assembly includes a motor and a gear train. The motor is disposed within the housing and is configured to be powered by the battery pack. The gear train is driven by the motor and configured to drive the cutting chain. The housing, the guide bar, and the power and drive assembly each contribute to a total weight of the chainsaw. A power output by the power and drive assembly compared to the total weight defines a power-to-weight ratio of above 150 Watts per Pound.

### CROSS-REFERENCE TO RELATED APPLICATIONS

This application claims priority to co-pending U.S. Provisional Patent Application No. 63/296,907 filed on Jan. 6, 2022, the entire content of which is incorporated herein by reference.

### FIELD OF THE INVENTION

The present invention relates to chainsaws, and more particularly to high power compact cordless chainsaws.

### BACKGROUND OF THE INVENTION

Chainsaws include chains which are driven about a guide bar to make cuts in work pieces. Conventional chainsaws are bulky, heavy, and either are gas or otherwise powered, or are battery powered. Conventional battery powered chainsaws are limited in instantaneous power output and sustained power output in terms of number of cuts per charge of the battery.

### SUMMARY OF THE INVENTION

In one embodiment invention provides, a chainsaw configured to be powered by a battery pack. The chainsaw includes a housing, a guide bar, and a power and drive assembly. The housing includes a battery interface for receiving the battery pack. The guide bar guides a cutting chain and is removably coupled to the housing. The power and drive assembly includes a motor and a gear train. The motor is disposed within the housing and is configured to be powered by the battery pack. The gear train is driven by the motor and configured to drive the cutting chain. The housing, the guide bar, and the power and drive assembly each contribute to a total weight of the chainsaw. A power output by the power and drive assembly compared to the total weight defines a power-to-weight ratio of above 150 Watts per Pound.

In another independent embodiment, the invention provides a chainsaw configured to be powered by a battery pack. The chainsaw includes a housing, a guide bar, and a power and drive assembly. The housing includes a battery interface for receiving the battery pack and defines a receptacle. The guide bar guides the cutting chain and is removably coupled to the housing. When coupled to the housing, the guide bar is at least partially received in the receptacle. The guide bar has a length extending between a distal end of the guide bar and the receptacle. The power and drive assembly is configured to drive the cutting chain about the guide bar. A power output of the power and drive assembly compared to the length of the guide bar defines a power-to-length ratio of above 140 Watts per inch.

In another independent embodiment, the invention provides a chainsaw configured to be powered by a battery pack. The chainsaw includes a housing, a guide bar, and a power and drive assembly. The housing includes a battery interface, the housing having a length. The guide bar guides a cutting chain and is removably coupled to the housing. The power and drive assembly is configured to drive the cutting chain about the guide bar. A power output of the power and drive assembly compared to the length of the housing defines a power-to-length ratio of above 75 Watts per inch.

### BRIEF DESCRIPTION OF THE DRAWINGS

FIG. 1 is a front perspective view of a chainsaw according to an embodiment.

FIG. 2 is another front perspective view of the chainsaw of FIG. 1 with a housing of the chainsaw removed.

FIG. 3 is a perspective view of a power and drive assembly of the chainsaw of FIG. 1.

FIG. 4 is a schematic view of an automatic oiling system of the chainsaw of FIG. 1.

FIG. 5 is an exploded view of the chainsaw of FIG. 1 with some components of the housing hidden to illustrate components of the automatic oiling system of FIG. 4.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

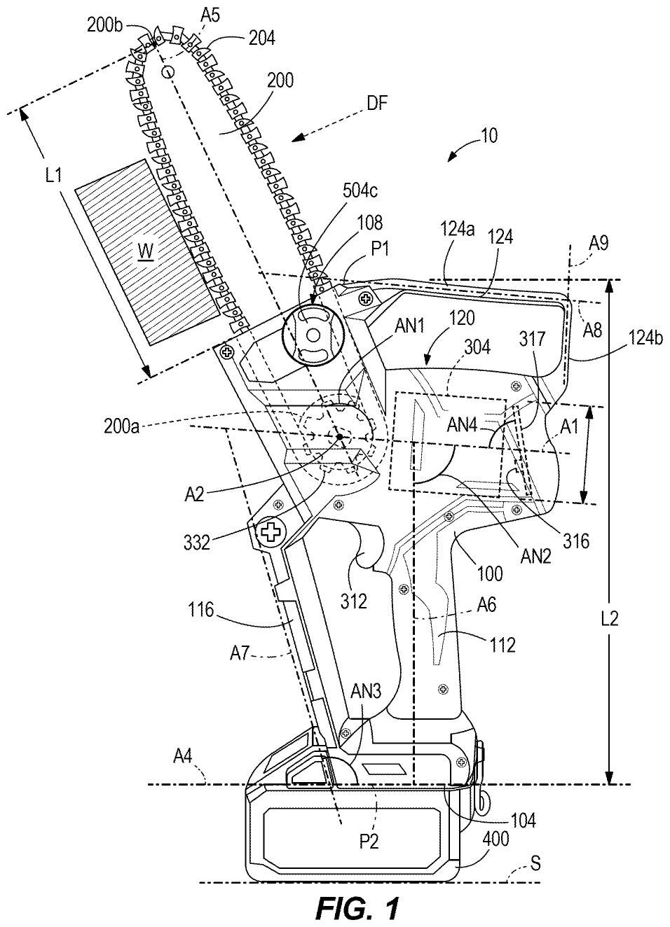

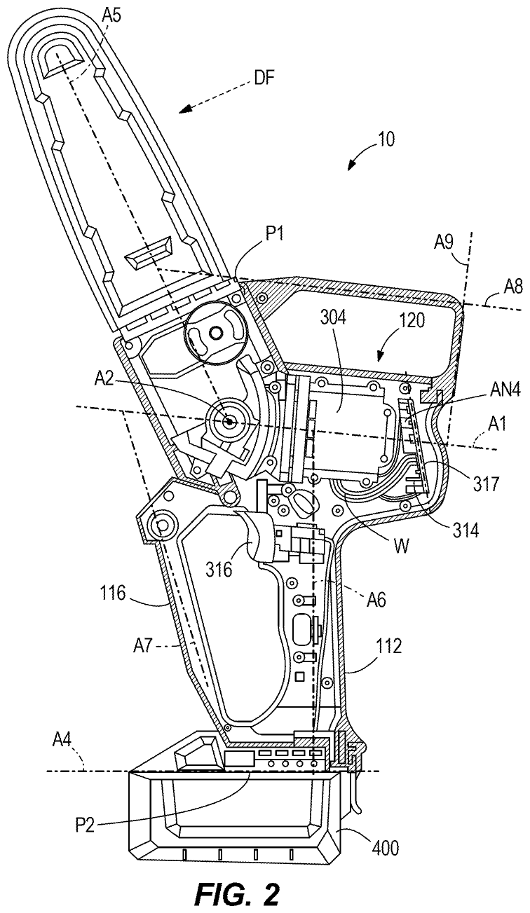

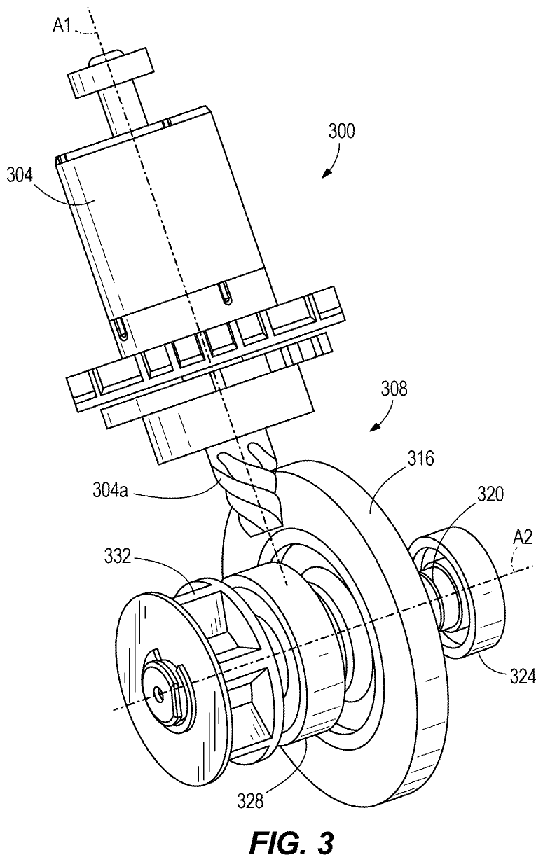

FIGS. 1 and 2 illustrate a power tool, such as a portable chainsaw 10. The chainsaw 10 includes a housing 100 and a guide bar 200 selectively coupled to the housing 100. The guide bar 200 supports a chain 204 (e.g., a cutting chain) that is driven around the guide bar 200 by a power and drive assembly 300 to make a cut in a workpiece W. The power and drive assembly 300 includes a motor 304 and a gear train 308 (FIG. 3) supported within the housing 100. The power and drive assembly 300 further includes a trigger 312 coupled with control electronics 314. The motor 304 is coupled to the control electronics 314, the control electronics 314 being capable of controlling operation of the motor 304. The control electronics 314 are configured to receive electrical input power from the battery pack 400 and operate the motor 304 to provide output mechanical power to drive the chain 204 around the guide bar 200. The portable chainsaw 10 is coupled to a battery pack 400 at a battery interface 104 of the housing 100. The portable chainsaw 10 is configured to be powered by the battery pack 400. The battery interface 104 electrically couples the battery pack 400 to the control electronics 314. Upon depressing the trigger 312, the control electronics 314 activate operation of the motor 304 to ultimately drive the chain 204 around the guide bar 200. To stop operation of the motor 304, the trigger 312 is released, and the chain 204 comes to rest upon the guide bar 200. As will be discussed in detail below, the portable chainsaw 10 further includes an automatic oiling assembly 500 coupled to the power and drive assembly 300 to provide oil from an on-board oil tank 504 to at least one of the guide bar 200 and the chain 204 during operation of the portable chainsaw 10.

FIG. 3 illustrates the power and drive assembly 300 in detail. The motor 304 is coupled to an output gear 304a. In the illustrated embodiment, the output gear 304a is a spiral bevel gear. The output gear 304a rotates about a motor axis A1. The output gear 304a of the motor 304 is coupled to a spiral bevel gear 316. The spiral bevel gear 316 is coupled to an output shaft 320. The spiral bevel gear 316 and the output shaft 320 rotate about a sprocket axis A2. In the illustrated embodiment, the sprocket axis A2 is generally perpendicular to the motor axis A1. The output shaft 320 is supported within the housing 100 by bearings 324, 328. The spiral bevel gear 316 is positioned between the bearings 324, 328. The output shaft 320 is further coupled to a chain sprocket 332. As best illustrated in FIG. 1, the chain 204 is coupled to the chain sprocket 332 for co-rotation therewith. In other words, the chain sprocket 332, a component of the gear train 308, is coupled to the chain 204, which is supported by the guide bar 200. Accordingly, while the motor 304 is operated, the output gear 304a rotates about the motor axis A1, and the spiral bevel gear 316, the output shaft 320, and the chain sprocket 332 rotate about the sprocket axis A2.

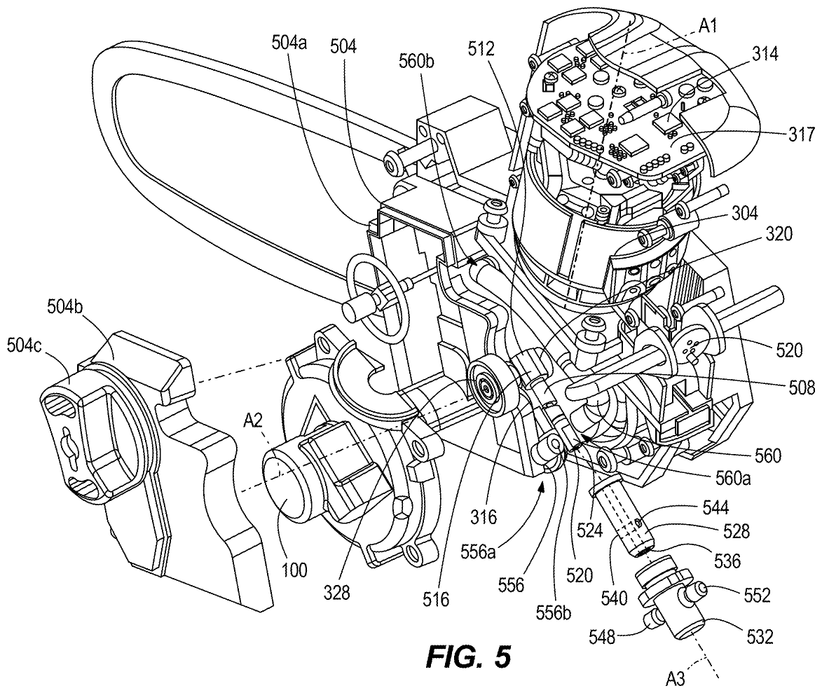

FIG. 5 illustrates the automatic oiling assembly 500 in detail. The oil tank 504 includes a housing portion 504a and a cap portion 504b. FIG. 5 illustrates the cap portion 504b removed from the housing portion 504a. The cap portion 504b is coupled to an adjustable (e.g., rotatable) knob 504c configured to adjust venting of external air into the oil tank 504. The automatic oiling assembly 500 includes an oiler shaft 508. The oiler shaft 508 has a first end 512 having spur teeth 516 and an opposite second end 520 having a key 524. The key 524 is dimensioned as a radially inwardly extending depression in the second end 520 of the oiler shaft 508. The spur teeth 516 engage the output shaft 320. Accordingly, as the output shaft 320 is rotated, the oiler shaft 508 rotated about an oiler axis A3.

The automatic oiling assembly 500 further includes a pump cylinder 528 and a pump housing 532. FIG. 5 illustrates the pump cylinder 528 and the pump housing 532 exploded from the oiler shaft 508. The pump cylinder 528 includes a passageway 536 within which the second end 520 of the oiler shaft 508 is received. The passageway 536 is in fluid communication with an inlet opening 540 and an outlet opening 544 each formed in the pump cylinder 528. The inlet opening 540 and the outlet opening 544 are on opposite radial sides of the passageway 536. In the assembly of the portable chainsaw 10, the pump cylinder 528 is located within the pump housing 532. The pump housing 532 includes a pump inlet 548 and a pump outlet 552. The pump inlet 548 is radially positioned adjacent the inlet opening 540, and the pump outlet 552 is radially positioned adjacent the outlet opening 544.

The automatic oiling assembly 500 further includes a pump inlet tube 556 with a first end 556a coupled to the oil tank 504 and an opposite second end 556b coupled to the pump inlet 548. The automatic oiling assembly 500 further includes a pump outlet tube 560 with a first end 560a coupled to the pump outlet 552 and a second end 560b terminating adjacent the guide bar 200 and the chain 204.

Accordingly, during operation of the portable chainsaw 10, the output shaft 320 rotates the oiler shaft 508. When the key 524 is aligned with the inlet opening 540, oil from the oil tank 504 is passed through the pump inlet tube 556 through the pump inlet 548 and the inlet opening 540 and to a location between the key 524 and the passageway 536. The output shaft 320 continues to rotate until the key 524 is aligned with the outlet opening 544. At this time, oil from between the key 524 and the passageway 536 is passed through the outlet opening 544 and the pump outlet 552 and through the pump outlet tube 560 to a position adjacent the guide bar 200 and the chain 204. Accordingly, the automatic oiling assembly 500 is driven by the gear train 308, the automatic oiling assembly 500 being configured to receive mechanical input from the gear train 308 and transmit oil from the oil tank 504 to at least one of the guide bar 200 and the chain receives oil from the oil tank 504. During operation of the automatic oiling assembly 500, the oiler shaft 508 including the key 524, in conjunction with the passageway 536 of the pump cylinder 528 function as a pump (e.g., an axial piston pump) to transmit oil from the oil tank 504 to at least one of the guide bar 200 and the chain 204. Other such pump mechanisms may be similarly driven by the output shaft 320. For example, the oiler shaft 508 may be configured to power other types of pumps, such as, and without limitation, an external gear pump, an internal gear pump, a gerotor pump, a peristaltic pump, or a lobe pump.

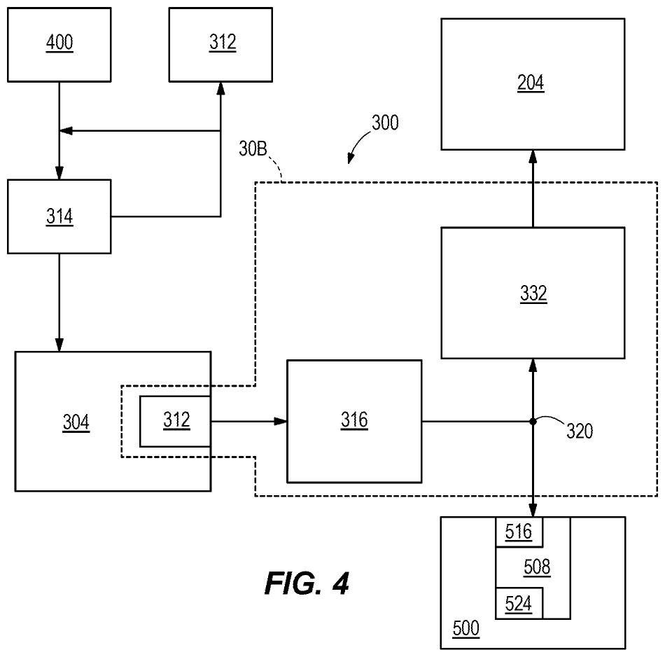

FIG. 4 schematically illustrates the operation of the portable chainsaw 10 through the power and drive assembly 300. The control electronics 314 receive power from the battery pack 400 and receive a signal to operate the motor 304 from the trigger 312 upon depression of the trigger 312. In some embodiments, the trigger 312 is also powered by the battery pack 400 through the control electronics 314. When the trigger 312 is depressed, the motor 304 is operated. The gear train 308 provides rotation to the output shaft 320 which powers rotation of the oiler shaft 508 of the automatic oiling assembly 500. The gear train 308 also provides rotation to the output shaft 320 which connects to the chain sprocket 332 and rotates the chain 204.

Returning to FIG. 1, various aspects of the portable chainsaw 10 relate to the configuration of the housing 100. As previously mentioned, the housing 100 includes the battery interface 104. The battery interface 104 is configured to receive the battery pack 400 upon translation of the battery pack along a battery axis A4. Once coupled to the battery interface 104, the battery pack 400 can rest on a surface S with the portable chainsaw 10 being supported (e.g., balanced) by the battery pack 400.

The housing 100 further includes a guide bar receptacle 108 within which at least a portion of the guide bar 200 is received. In the illustrated embodiment, the guide bar receptacle 108 is positioned generally on the opposite end of the housing 100 as the battery interface 104. With continued reference to FIG. 1, the guide bar 200 includes a proximal end 200a and an opposite distal end 200b. The proximal end 200a is located adjacent the sprocket 332 within the guide bar receptacle 108. The distal end 200b projects from the guide bar receptacle 108 such that at least a portion of the chain 204 can make a cut in a workpiece W. The guide bar 200 extends along a guide bar axis A5 between the proximal end 200a and the distal end 200b. The guide bar 200 defines a guide bar length L1 extending between the distal end 200b and the guide bar receptacle 108. In other words, the guide bar length L1 represents the exposed portion of the guide bar 200 projecting from the housing 100. In the illustrated embodiment, the guide bar length L1 is approximately 7.5 inches (19 centimeters). The illustrated guide bar 200 extends between the proximal end 200a and the distal end 200b of approximately 9.5 inches (24 centimeters). The illustrated guide bar 200 may be advertised, for example, as an 8-inch (20 centimeter) guide bar 200. Other lengths L1, distances between the proximal end and the distal end 200a, 200b, and advertised guide bar size are possible. The guide bar 200 may be a removable (i.e., selectively couplable) guide bar 200 which can be removed from the housing 100 for transport of the chainsaw 10 or replacement of the guide bar 200. In some embodiments, the guide bar 200 may also be movable (i.e., selectively positionable) along the guide bar axis A5 relative to the housing 100 into and out of the guide bar receptacle 108 for tensioning the chain 204.

With continued reference to FIG. 1, the guide bar axis A5 crosses the motor axis A1 at the sprocket axis A2. The guide bar axis A5 also extends away from the motor axis A1 and the motor 304 at an oblique angle AN1. In the illustrated embodiment, the angle AN1 is approximately 120 degrees. Other angles AN1 are possible.

The housing 100 further includes a primary handle 112 extending between the motor 304 and the battery interface 104 along a primary handle axis A6. The primary handle axis A6 is generally perpendicular to the battery axis A4. The primary handle axis A6 traverses the motor axis A1 at an angle AN2. The angle AN2 is near perpendicular, but is slightly less than 90 degrees. For example, in the illustrated embodiment, the angle AN2 is approximately 86 degrees. Other angles AN2 are possible.

The housing 100 further includes a handle guard 116 coupled to the battery interface 104 and extending generally toward the guide bar 200. The trigger 312 is positioned between the primary handle 112 and the handle guard 116. Accordingly, during use of the portable chainsaw 10, an operator's hand holding the primary handle 112 and touching the trigger 312 may be shielded from any cuttings generated by the chain 204. The handle guard 116 extends along a guard axis A7. In the illustrated embodiment, the guard axis A7 is angled relative to the battery axis A4 an angle AN3. The angle AN3 in the illustrated embodiment is oblique. The angle AN3 in the illustrated embodiment is an obtuse angle, and is approximately 106 degrees. Other angles AN3 are possible.

The housing 100 further includes a motor receptacle 120 within which the motor 304 is received. The portable chainsaw 10 further includes a hand guard 124 coupled to the guide bar receptacle 108 and the motor receptacle 120. The hand guard 124 includes a first portion 124a and a second portion 124b. The first portion 124a extends along a first hand guard axis A8. In some embodiments, the first portion 124a may have indicia to indicate to a user not to grasp the hand guard 124. The second portion 124b extends along a second hand guard axis A9. The first hand guard axis A8 is generally parallel with the motor axis A1. The second hand guard axis A9 is generally perpendicular with the motor axis A1. The hand guard 124 may inhibit debris or other material from contacting a user.

With continued reference to FIG. 1, the portable chainsaw 10 is compact. The housing 100 defines a first point P1 and a second point P2 offset a maximum housing length L2 from one another. The maximum housing length L2 may account for the housing 100 size without considering different sized and/or positioned battery packs 400 and/or guide bars 200. In the illustrated embodiment, the maximum housing length L2 is approximately 12 inches (30 centimeters). Other portable chainsaws 10 may have differing maximum housing lengths L2. In the illustrated embodiment, the maximum housing length L2 is measured in a plane defined by the guide bar axis A5 and the motor axis A1.

One consideration that allows the portable chainsaw 10 to be compact is the location of the control electronics 314. In the illustrated embodiment, at least one component of the control electronics 314 is mounted upon a printed circuit board 317. The printed circuit board 317 is positioned within the motor receptacle 120 at a position opposite the motor 304 when compared to the gear train 308 (the gear train 308 including the sprocket 332). The motor axis A1 passes through the printed circuit board 317. The printed circuit board 317 is angled relative to the motor axis A1 at an angle AN4. The angle AN4 in the illustrated embodiment is acute and is approximately 76 degrees. Other angles AN4 are possible.

Various components of the portable chainsaw 10 contribute to high power-output and high efficiency of the chainsaw 10, leading to high performance of the portable chainsaw 10. First, the battery pack 400 is a high-performance battery pack 400. In the illustrated embodiment, the battery pack 400 is lithium-based. Other battery packs may be nickel-based, or have differing chemistries. The battery pack 400 may be a high-output battery pack (e.g., 6.0 Ah), such as the M18™ REDLITHIUM™ HIGH OUTPUT™ XC6.0 battery pack, manufactured and sold by Milwaukee Electric Tool, Milwaukee, Wis. Such a battery pack 400 weighs approximately 2.3 pounds (1.0 kilograms). The battery pack 400 may be operable to provide at least 1000 Watts of electrical input power to the power and drive assembly 300. In some embodiments, the battery pack 400 has an operating voltage of approximately 18 volts. The battery pack 400 may have, for example, an output current of 6.0 amps. Other suitable battery packs 400 may have different operating voltages, output currents, power outputs, and/or different weights.

The battery pack 400 is also a high-capacity battery pack 400. When the battery pack 400 is used to power the portable chainsaw 10, the battery pack 400 is configured to make at least 150 cuts of 3.5-inch by 3.5-inch (8.9-centimeter by 8.9-centimeter) (e.g., a piece of dimensional lumber commonly referred to as a “four by four”) pressure-treated lumber on a single charge. For instance, the pressure-treated lumber may be pine. The battery pack 400 can make at least 160 cuts of 3.5-inch by 3.5-inch (8.9-centimeter by 8.9-centimeter) pressure-treated lumber on a single charge. In some instances, the battery pack 400 can make 179 cuts of 4-inch by 4-inch (10 centimeter by 10-centimeter) pressure-treated lumber on a single charge. Similarly, when the battery pack 400 is used to power the portable chainsaw 10, the battery pack 400 is configured to make at least 80 cuts of 5.5-inch by 5.5-inch (14-centimeter by 14-centimeter) (e.g., a piece of dimensional lumber commonly referred to as a “six by six”) pressure-treated lumber on a single charge. In fact, the battery pack 400 can make at least 89 cuts of 5.5-inch by 5.5-inch (14-centimeter by 14-centimeter) pressure-treated lumber on a single charge.

During cutting of the 3.5-inch by 3.5-inch (8.9-centimeter by 8.9-centimeter) and 5.5-inch by 5.5-inch (14-centimeter by 14-centimeter) pressure-treated lumber, a downforce of approximately 30 pounds (13.6 kilograms) was applied to the portable chainsaw 10 in a direction DF (FIGS. 1, 2). While cutting through a workpiece W of 3.5-inch by 3.5-inch (8.9-centimeter by 8.9-centimeter) pressure-treated lumber and while applying a downforce of 30 pounds (13.6 kilograms) in the direction DF, the chainsaw 10 cut through the 3.5-inch by 3.5-inch (8.9-centimeter by 8.9-centimeter) pressure-treated lumber in approximately 3.07 seconds. In other words, the 3.5-inch by 3.5-inch (8.9-centimeter by 8.9-centimeter) pressure-treated lumber was cut within 3.5 seconds. Accordingly, the guide bar 200 was passed at speed of (3.5 inches/3.07 seconds, 8.89 centimeters/3.07 seconds) about 1.14 inches per second (2.89 centimeters per second). While cutting through a workpiece W of 5.5-inch by 5.5-inch (14-centimeter by 14-centimeter) pressure-treated lumber and while applying a downforce of 30 pounds (13.6 kilograms) in the direction DF, the chainsaw 10 cut through the 5.5-inch by 5.5-inch (14-centimeter by 14-centimeter) pressure-treated lumber in approximately 5.97 seconds. In other words, the 5.5-inch by 5.5-inch (14-centimeter by 14-centimeter) pressure-treated lumber was cut within 6.25 seconds. Accordingly, the guide bar 200 was passed at speed of (5.5 inches/5.97 seconds, 13.97 centimeters/5.97 seconds) about 0.92 inches per second (2.34 centimeters per second).

The control electronics 314 and the printed circuit board 317 must also be constructed of adequate quality (e.g., size, capacity) to provide adequate capacity to transmit the at least 1000 Watts of electrical input power to the motor 304. For example, wires W (FIG. 3) coupling the battery pack 400 to the control electronics 314 and the printed circuit board 317 must be adequately sized. Further, the control electronics 314 and the printed circuit board 317 must be adequately cooled during operation of the portable chainsaw 10.

Next, the motor 304 must be a high-power motor 304. The motor 304 must operate at torque and speed configured to provide output mechanical power to drive the chain 204 around the guide bar. In some embodiments, this output mechanical power is at least 1000 Watts. The motor 304 is operable to output a maximum output power while cutting a workpiece of 3.5-inch by 3.5-inch (8.9-centimeter by 8.9-centimeter) pressure-treated lumber of at least 1100 Watts. In the illustrated embodiment, the motor 304 can reach instantaneous mechanical output power of approximately 1200 Watts. This instantaneous mechanical output power was observed while the portable chainsaw 10 cut a 3.5-inch by 3.5-inch (8.9-centimeter by 8.9-centimeter) piece of pressure-treated lumber.

The automatic oiling assembly 500 may provide adequate amounts of lubrication to at least one of the guide bar 200 and the chain 204 to inhibit excess undesired heat production during rotation of the chain 204 about the guide bar 200. Such undesired heat production may cause binding of the chain 204 upon the guide bar 200, inhibiting a cutting operation of the chainsaw 10. Oil from the automatic oiling assembly 500 may absorb at least some of the heat generated between the chain 204 and the guide bar 200. The automatic oiling assembly 500 is sized to provide an adequate volumetric flow rate of lubrication from the oil tank 504 to at least one of the guide bar 200 and the chain 204. Accordingly, large amounts of power (e.g., at least a maximum of 1200 Watts, as further described below) may be applied through the chain 204 to the workpiece W without overheating of the guide bar 200 and chain 204, which may cause binding of the chain 204 onto the guide bar 200.

The housing 100 and the fastening of each of the components of the portable chainsaw 10 thereto are capable of withstanding forces generated while applying high amounts of power to the workpiece W. For example, the fastening mechanism between the guide bar 200 and the housing 100 is rigid enough to withstand both the forces generated by the chain 204 as well as the downforce in direction DF. Similarly, the bearings 324, 328 which support the output shaft 320 within thin the housing 100 can withstand the forces placed thereon during high power-output cutting of the chainsaw 10.

Each of the materials of each of the components (e.g., the guide bar 200, the motor 304, the housing 100) of the chainsaw 10 are selected to minimize weight of the chainsaw 10 while providing adequate capacity to operate the chainsaw 10 at a high power-output. For example, the guide bar 200 may be a lightweight and high strength steel alloy, stainless-steel alloy, aluminum alloy, or the like. Accordingly, the guide bar 200 may resist corrosion, hold strong edges for engaging the chain 204, while retaining enough elasticity to bend under high stress without breaking. The motor 304 may also be a lightweight and high power-output motor such as, without limitation, a brushless direct current motor. In other words, the motor 304 may have a high power-to-weight (i.e., PWR, i.e., specific power) ratio. Another example of lightweight component selection in the chainsaw 10 is the housing 100 itself. The housing 100 may be composed of a durable and light-weight plastic material. The housing 100 may optionally be formed of injection molded plastic comprising of a base material and an additive. The base material and the additive of the housing 100 each contributing to the structural rigidity and weight of the housing 100. Total weight of the chainsaw 10 less the battery pack 400 (i.e., including the guide bar 200, the power and drive assembly 300, and the housing 100) in the illustrated embodiment is approximately 4.74 pounds (2.15 kilograms). Other embodiments may have different total weights for the chainsaw 10.

The above-described features of the chainsaw 10 provide a high power-output and light weight chainsaw 10 with a compact guide bar 200 and a compact housing 100. As previously mentioned, a maximum instantaneous mechanical output power of the chainsaw 10 while cutting 3.5-inch by 3.5-inch (8.9-centimeter by 8.9-centimeter) pressure-treated lumber is approximately 1200 Watts. Other improved higher output chainsaws are envisioned upon realizing increases in efficiency of components of the chainsaw 10.

As previously mentioned, the weight of the chainsaw 10 less (i.e., without) the battery pack 400 is approximately 4.74 pounds, and the maximum output power of the chainsaw 10 is approximately 1200 Watts. Accordingly, the chainsaw 10 is a high power-output and lightweight chainsaw having a power-to-weight ratio of output mechanical power to total weight above 150 Watts per pound (330 Watts per kilogram). More specifically, the chainsaw 10 has a power-to-weight ratio of output mechanical power to total weight above 250 Watts per pound (550 Watts per kilogram). The illustrated chainsaw 10 has a power-to-weight ratio of output mechanical power to total weight of approximately 253 Watts per pound (557 Watts per kilogram).

As previously mentioned, the guide bar length L1 of the illustrated guide bar 200 is approximately 7.5 inches (19 centimeters), and the maximum output power of the chainsaw 10 is approximately 1200 Watts. Accordingly, the chainsaw 10 is a high power-output and compact guide bar 200 chainsaw 10 having a power-to-length ratio of output mechanical power to guide bar length L1 greater than 100 Watts per inch (39 Watts per centimeter). More specifically, the chainsaw 10 has a power-to-length ratio of output mechanical power to guide bar length L1 greater than 140 Watts per inch (55 Watts per centimeter). The illustrated chainsaw 10 has power-to-length ratio of output mechanical power to guide bar length L1 approximately 160 Watts per inch (63 Watts per centimeter).

As previously mentioned, the maximum housing length L2 of the illustrated housing 100 is approximately 12 inches, and the maximum output power of the chainsaw 10 is approximately 1200 Watts. Accordingly, the chainsaw 10 is a high power-output and compact housing 100 chainsaw 10 having a power-to-length ratio of output mechanical power to maximum housing length L2 greater than 50 Watts per inch (20 Watts per centimeter). More specifically, the chainsaw 10 has a power-to-length ratio of output mechanical power to maximum housing length L2 greater than 75 Watts per inch (30 Watts per centimeter). The illustrated chainsaw 10 has power-to-length ratio of output mechanical power to maximum housing length L2 approximately 100 Watts per inch (40 Watts per centimeter).

Although the invention has been described in detail with reference to certain preferred embodiments, variations and modifications exist within the scope and spirit of one or more independent aspects of the invention as described.

Various features of the invention are set forth in the following claims.

What is claimed is:

1. A chainsaw configured to be powered by a battery pack, the chainsaw comprising:
a housing including a battery interface for receiving the battery pack;
a guide bar for guiding a cutting chain, the guide bar removably coupled to the housing;
a power and drive assembly including
a motor disposed within the housing, the motor configured to be powered by the battery pack, and
a gear train driven by the motor and configured to drive the cutting chain;
wherein the housing, the guide bar, and the power and drive assembly each contribute to a total weight of the chainsaw; and
wherein a power output by the power and drive assembly compared to the total weight defines a power-to-weight ratio of above 150 Watts per Pound.

2. The chainsaw of claim 1, wherein the power-to-weight ratio is above 250 Watts per Pound.

3. The chainsaw of claim 1, wherein an operating voltage of the battery pack is approximately 18 Volts.

4. The chainsaw of claim 1, wherein the chainsaw is operable to cut through a workpiece of 3.5-inch by 3.5-inch pressure-treated lumber within 3.5 seconds.

5. The chainsaw of claim 4, wherein the chainsaw is configured to make at least 150 cuts of 3.5-inch by 3.5-inch pressure-treated lumber on a single charge of the battery pack.

6. The chainsaw of claim 1, wherein the chainsaw is operable to cut through a workpiece of 5.5-inch by 5.5-inch pressure-treated lumber within 6.25 seconds.

7. The chainsaw of claim 6, wherein the chainsaw is configured to make at least 80 cuts of 5.5-inch by 5.5-inch pressure-treated lumber on a single charge of the battery pack.

8. The chainsaw of claim 1, wherein the motor is a high-efficiency brushless direct current motor having an output of at least 1000 Watts.

9. The chainsaw of claim 8, wherein the motor has a maximum output of at least 1100 Watts while cutting a workpiece of 3.5-inch by 3.5-inch pressure-treated lumber.

10. The chainsaw of claim 9, wherein the motor is configured to receive at least 1000 Watts from the battery pack.

11. A chainsaw configured to be powered by a battery pack, the chainsaw comprising:
a housing including a battery interface for receiving the battery pack, the housing defining a receptacle;
a guide bar for guiding a cutting chain, the guide bar removably coupled to the housing, when coupled to the housing the guide bar being at least partially received in the receptacle, the guide bar having a length extending between a distal end of the guide bar and the receptacle;
a power and drive assembly configured to drive the cutting chain about the guide bar; and
wherein a power output of the power and drive assembly compared to the length of the guide bar defines a power-to-length ratio of above 140 Watts per inch.

12. The chainsaw of claim 11, wherein the chainsaw further comprises an automatic oiling assembly driven by the power and drive assembly, the automatic oiling assembly comprising an on-board oil tank, the automatic oiling assembly being configured to transmit oil from the on-board oil tank to at least one of the guide bar and the chain.

13. The chainsaw of claim 12, wherein
the power and drive assembly further includes a gear train having an output shaft, and
the automatic oiling assembly includes an oiler shaft having
a first end, the first end having spur teeth coupled to the output shaft, and
a second end opposite the first end, the second end having a key, the key configured to function as a pump to transmit oil from the on-board oil tank to at least one of the guide bar and the chain.

14. A chainsaw configured to be powered by a battery pack, the chainsaw comprising:
a housing including a battery interface, the housing having a length;
a guide bar for guiding a cutting chain, the guide bar removably coupled to the housing;
a power and drive assembly configured to drive the cutting chain about the guide bar; and
wherein a power output of the power and drive assembly compared to the length of the housing defines a power-to-length ratio of above 75 Watts per inch.

15. The chainsaw of claim 14, wherein the housing includes a guide bar receptacle within which at least a portion of the guide bar is received.

16. The chainsaw of claim 14, wherein the length extends between a first point defined by the guide bar receptacle and a second point defined by the battery interface.

17. The chainsaw of claim 14, wherein
the power and drive assembly includes a motor having a motor axis,
the guide bar has a guide bar axis,
the guide bar axis extends away from the motor, and
the guide bar axis and the motor axis intersect at an oblique angle.

18. The chainsaw of claim 14, wherein
the housing further includes
a primary handle extending between the motor and the battery interface, and
a handle guard coupled to the battery interface, and
the power and drive assembly further includes a trigger positioned between the primary handle and the handle guard.

19. The chainsaw of claim 14, wherein
the housing includes
a motor receptacle within which the motor is received, and
a guide bar receptacle within which at least a portion of the guide bar is received, and
the chainsaw further comprises a hand guard coupled to the guide bar receptacle and the motor receptacle.

20. The chainsaw of claim 14, wherein
the power and drive assembly further comprises
a motor, and
a printed circuit board in electrical communication with the motor, and
the motor is positioned between the printed circuit board and the guide bar.
